(19) United States
(12) Patent Application Publication
(10) Pub. No.: US 2007/0252440 A1
(43) Pub. Date: Nov. 1, 2007

(54) Method and System for Providing Power

(75) Inventors: Craig A. Zimmerman, Austin, TX (US); Earl W. Boone, Round Rock, TX (US); Vinod Cherukatt, Sunnyvale, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/380,865

(22) Filed: Apr. 28, 2006

(51) Int. Cl. H02J 9/00

(52) U.S. Cl. 307/64

(57) ABSTRACT

According to one embodiment of the invention, a method for providing power includes providing a telecommunication switch coupled to a backup power supply by a communication path that allows communication of control information from the telecommunication switch to the backup power supply. The method also includes providing a primary power supply operable to provide power to the telecommunication switch and terminating, by the telecommunication switch, power to the telecommunication switch from the primary power supply.

### TECHNICAL FIELD OF THE INVENTION

This invention relates generally to power supplies and more particularly to a method and system for providing power.

### BACKGROUND OF THE INVENTION

Power supplies are used in association with telecommunication switches and other devices. It is commonplace for a redundant power supply to be utilized in conjunction with a telecommunication switch, or other device, in instances where it is important that the telecommunication switch provide continuous operation in the event of failure in the primary power supply. Conventionally, if the primary power supply fails, the redundant power supply turns on and provides power to the telecommunications switch.

Conventionally, in order to detect the proper operation of the redundant power supply, the primary power supply was physically brought down, and operation of the backup power supply (also known as redundant power supply (RPS)) was examined. Further, the backup power supply would have to be disconnected from the telecommunication switch when the test concluded. This testing procedure can be problematic because it requires hands-on attention by personnel to shut down the primary supply and to shut down the backup supply after the test is completed. In addition, backup power supplies conventionally could not receive communications from the associated telecommunication switch, but could only provide one way status information from the power supply to the switch.

### SUMMARY OF THE INVENTION

According to one embodiment of the invention, a method for providing power includes providing a telecommunication switch coupled to a backup power supply by a communication path that allows communication of control information from the telecommunication switch to the backup power supply. The method also includes providing a primary power supply operable to provide power to the telecommunication switch and terminating, by the telecommunication switch, power to the telecommunication switch from the primary power supply.

Embodiments of the invention may provide numerous technical advantages. Some, none, or all embodiments may benefit from the below described advantages. According to one embodiment, proper working of a backup power supply may be tested without manual intervention. This provides an efficient manner of confirming that uninterrupted power is available, without the conventional associated costs of manually bringing down a power supply to determine if the associated backup power supply would function properly. Further, in some embodiments, the primary power supply may be automatically turned on by a telecommunication switch and the backup power may be turned off by the telecommunication switch, allowing return to normal operating conditions without manual intervention.

Other technical advantages will be apparent to one of skill in the art.

### BRIEF DESCRIPTION OF THE DRAWINGS

A more complete understanding of embodiments of the invention will be apparent from the detailed description taken in conjunction with the accompanying drawings in which:

FIG. 1 is a block diagram of a telecommunication system according to the teachings of the invention;

FIG. 2 is a flowchart illustrating example acts associated with providing power to the telecommunication switch of FIG. 1; and

FIG. 3 is a flowchart illustrating example acts associated with additional acts associated with providing power to the telecommunication switch of FIG. 1.

### DETAILED DESCRIPTION OF EXAMPLE EMBODIMENTS OF THE INVENTION

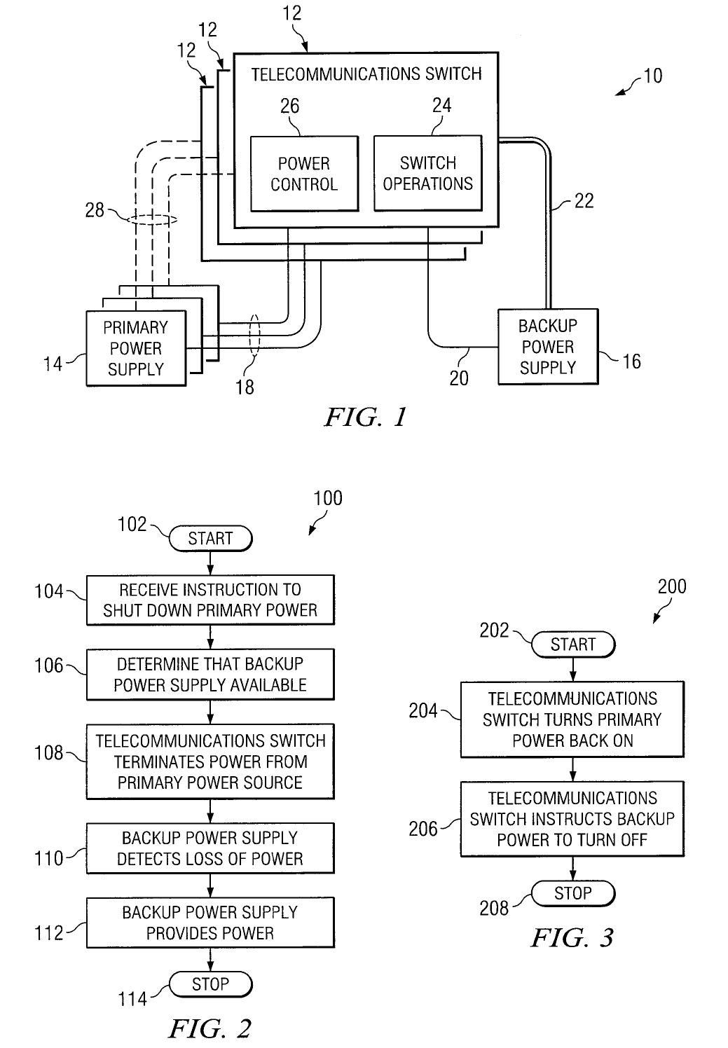

Example embodiments of the present invention and their advantages are best understood by referring to FIGS. 1 through 3 of the drawings, like numerals being used for like and corresponding parts of the various drawings.

FIG. 1 is a block diagram of a telecommunication system according to the teachings of the invention. Telecommunication system 10 includes a telecommunication switch 12, a primary power supply 14, and a backup power supply 16. Primary power supply is communicatively coupled to telecommunication switch 12 by a link 18, and backup power supply 16 is communicatively coupled to telecommunication switch 12 by a link 20. Links 18 and 20 provide power from the respective power supply 14, 16 to telecommunication switch 12, and links 18 and 20 may be in any suitable form operable to communicate the required power for telecommunication switch 12 from the respective power supply. Telecommunication system 10 also includes a communications channel 22 coupling backup power supply 16 to telecommunication switch 12. As described in greater detail below, communication channel 22 allows communication of control information from the telecommunication switch to the backup power supply.

Telecommunication switch 12 may be any telecommunication switch operable to switch, or route, telecommunication messages, including those formatted in the IP protocol, or other protocol. Alternatively, telecommunication switch 12 could be replaced with other apparatuses that utilize both primary and backup power that are not telecommunication switches. In this example, telecommunication switch 12 includes a power control module 26 and a switching operations module 24. Switching operations module 24 is associated with telecommunication switch 12 performing its switching function. Power control module 26 contains logic associated with provision of power to telecommunication switch 12 by primary power supply 14 and backup power supply 16. In particular, power control module 26 may communicate with backup power supply 16 over communication channel 22, as described in greater detail below.

As described above, in order to test conventional backup power supply systems the primary power supply must be physically shut down, and then a check is made to determine whether the backup power supply provided power in response. Such an approach required manual intervention which could be time consuming and costly. According to the teachings of the invention, telecommunication switch 12, and in particular power control module 26, is able to automatically terminate power supply from primary power supply 14 to telecommunication switch 12. And power control module 26 is able to communicate with backup power supply 16 to determine if backup power supply 16 is available to provide backup power.

Communication between power control module 26 of telecommunication switch 12 and backup power supply 16 occurs over communications path 22. In particular, communication path 22 provides two-way communication between power control module 26 and backup power supply 16, as described in greater detail below. Control over the supply of power from primary power supply 14 may occur in several ways. For example, in one example the power is terminated by a physical switch on telecommunication switch 12. Conversely, a communications path may be provided between telecommunication switch 12 and primary power supply 14 that allows communication from telecommunication switch 12 to primary power supply 14 that primary power supply 14 should terminate power to telecommunication switch 12. This communications path 28, illustrated in a dotted line in FIG. 1 may be the same or different path as path 18.

In one example, communications channel 22 may be a serial management bus. Example information that may be provided by backup power supply 16 is the identity of the power supply, what it is capable of backing up, and whether it is already in use. It is not uncommon for a single backup power supply, such as backup power supply 16, to be coupled to a plurality of different telecommunication switches, and thus it is possible that a backup power supply will already be in use when needed by telecommunication switch 12.

This enabling of the power at primary power supply 14 may take place, in one example, by use of an enable bit to disable supply of power from primary power supply 14 to telecommunication switch 12. As described above, in one example, the power may be shut off at primary power supply 14; however, in an alternative embodiment the power may be terminated at telecommunication switch 12, or another suitable location, such as within line 18. The instruction to terminate power may involve receiving an instruction from a keyboard, such as from a user, through a scheduled maintenance, or through another approach. Additional details are described with reference to FIGS. 2 and 3.

FIG. 2 is a flowchart illustrating example acts associated with providing backup power in a telecommunication system (or other type of system), such as the one illustrated in FIG. 1, in this embodiment. The acts described with respect to FIGS. 2 and 3 may be performed predominantly by power control module 26, which may include software implementations, hardware implementations, or a combination of the two. Method 100 begins at step 102. At step 104, an instruction is received to shut down primary power. As described above, this instruction may occur from a keyboard, or other user interaction, or may occur automatically, such as through a scheduled maintenance. At step 106, a determination is made that backup power supply 16 is available. This may occur through communication switch 12 sending a request to backup power supply 16 and backup power supply 16 returning an answer.

At step 108, assuming backup power supply 16 is available, telecommunication switch 12 terminates power from primary power supply 14. This occurs at step 108. In one example, such power from primary power supply 14 is terminated through the transmission of an enable bit from telecommunication switch 12 to primary power supply 14 over path 22. In response to the disabling of power, backup power supply 16 detects the loss of power by a telecommunication switch according to conventional techniques. Alternatively, future developments may present additional ways in which backup power supply 16 may detect loss of power to telecommunication switch 12. In response to the loss of power to telecommunication switch, backup power supply 16 provides power over path 20 to telecommunication switch 12 at step 112. The method concludes at step 114.

Thus, according to the teachings of the invention, a test of the proper operation of backup power supply 16 can be effected without manually pulling the plug to primary power supply 14. Once backup power supply 16 has been tested, it is useful to restore telecommunication switch 12 to operate using power supplied by primary power supply 14. Conventionally, in order to effect such return to standard operations, the backup power supply had to be manually disconnected to bring the primary power supply back up to operation. According to another aspect of the invention, this manual disconnection of backup power supply 16 may be avoided, as described in greater detail in FIG. 3.

FIG. 3 is a flowchart illustrating a method 200 for restoring power delivery from primary power supply 14 to telecommunication switch 12. The method begins at step 202. At step 204, telecommunication switch 12 turns the primary power back on to primary power supply 14 by providing an enable bit to primary power supply 14, in this embodiment. Further, telecommunication switch 12 communicates with backup power supply 16 over communication channel 22 instructing backup power supply 16 to turn itself off at step 206. The method concludes at step 208. By providing a communications channel between telecommunication switch 12 and backup power supply 16 that allows communication of information from telecommunication switch 12 to backup power supply 16, operation of telecommunication switch 12 using power from primary power supply 14 may be effected without pulling the associated backup power supply plug.

Although the present invention and its advantages have been described in detail, it should be understood that various changes, substitutions, and alterations can be made therein without departing from the spirit and scope of the invention as defined by the appended claims.

What is claimed is:

1. A method for providing power comprising:
providing a telecommunication switch coupled to a backup power supply by a communications path that allows communication of control information from the telecommunication switch to the backup power supply;
providing a primary power supply operable to provide power for the telecommunication switch; and
terminating, by the telecommunication switch, power to the telecommunication switch from the primary power supply.

2. The method of claim 1, wherein terminating, by the telecommunication switch, power to the telecommunication switch comprises terminating power by transmitting a disable bit to the primary power supply.

3. The method of claim 1, wherein terminating, by the telecommunication switch, power to the telecommunication switch comprises terminating power in response to receipt by the telecommunication switch of an instruction to terminate power.

4. The method of claim 1, wherein terminating, by the telecommunication switch, power to the telecommunication switch comprises terminating power by software within the telecommunication switch.

5. The method of claim 1, wherein terminating, by the telecommunication switch, power to the telecommunication switch comprises terminating power by hardware within the telecommunication switch.

6. The method of claim 1, and further comprising determining, by the telecommunication switch, that the backup power supply is available to provide power before terminating, by the telecommunication switch, power to the telecommunication switch from the primary power supply.

7. The method of claim 1, wherein providing a telecommunication switch coupled to a backup power supply by a communication path comprises providing a telecommunication switch coupled to a backup power supply by a serial management bus.

8. The method of claim 1, and further comprising communicating from the telecommunication switch, over the communication path between the telecommunication switch and the backup power supply, control information instructing the backup power supply to terminate providing power to the telecommunication switch.

9. The method of claim 1, and further comprising providing, over the communication channel, information from the backup power supply to the telecommunication switch selected from the group consisting of the identity of the backup power supply, the capability of the backup power supply, and the usage state of the backup power supply.

10. A telecommunication system comprising:
a telecommunication switch;
a primary power supply operable to provide power to the telecommunication switch;
a backup power supply operable to provide backup power for the telecommunication switch;
a communication channel communicatively coupling the backup power supply to the telecommunication switch; and
wherein the telecommunication switch is operable to:
ascertain the status of the backup power supply;
automatically terminate supply power to the telecommunication switch from the primary power supply; and
instruct, by the communication channel, the backup power supply to terminate power to the telecommunication switch.

11. The system of claim 10, wherein the telecommunication switch is further operable to automatically terminate supply of power to the telecommunication switch from the primary power supply in response to a determination that the backup power supply is available to provide power to the telecommunication switch.

12. The system of claim 10, wherein the telecommunication switch is further operable to terminate supply of power to the telecommunication switch from the primary power supply in response to receiving an instruction to terminate the power supply from the primary power supply.

13. The system of claim 10, wherein the communication channel comprises a serial management bus.

14. The system of claim 10, wherein the telecommunication switch is further operable to automatically terminate supply of power to the communication switch from the primary power supply by software command.

15. The system of claim 10, wherein the telecommunication switch is further operable to automatically terminate supply of power to the communication switch from the primary power supply by hardware command.

16. The system of claim 10, wherein the telecommunication switch is further operable to automatically terminate supply of power to the communication switch from the primary power supply by disabling a disable bit of the primary power supply.

17. The system of claim 10, wherein the telecommunication switch is further operable to automatically terminate supply of power to the communication switch from the primary power supply by terminating power output of the primary power supply.

18. The system of claim 10, wherein the telecommunication switch is further operable to automatically terminate supply of power to the communication switch from the primary power supply by terminating input of power from the primary power supply to the telecommunication switch.

19. A method for providing power comprising:
providing an apparatus coupled to a backup power supply by a communications path that allows communication of control information from the apparatus to the backup power supply;
providing a primary power supply operable to provide power for the apparatus; and
terminating, by the apparatus, power to the telecommunication switch from the primary power supply.

20. The method of claim 19, wherein terminating, by the apparatus, power to the apparatus comprises terminating power by transmitting a disabled bit to the primary power supply.

21. The method of claim 19, wherein terminating, by the apparatus, power to the apparatus comprises terminating power in response to receipt by the apparatus of an instruction to terminate power.

22. The method of claim 19, wherein terminating, by the apparatus, power to the apparatus comprises terminating power by software within the apparatus.

23. The method of claim 19, wherein terminating, by the apparatus, power to the apparatus comprises terminating power by hardware within the apparatus.

24. The method of claim 19, and further comprising determining, by the apparatus, that the backup power supply is available to provide power before terminating, by the apparatus, power to the apparatus from the primary power supply.

25. The method of claim 19, wherein providing a apparatus coupled to a backup power supply by a communication path comprises providing a apparatus coupled to a backup power supply by a serial management bus.

26. The method of claim 19, and further comprising communicating from the apparatus, over the communication path between the apparatus and the backup power supply, control information instructing the backup power supply to terminate providing power to the apparatus.

27. A telecommunication system comprising:
a telecommunication switch;
a primary power supply operable to provide power to the telecommunication switch;
a backup power supply operable to provide backup power for the telecommunication switch;
a communication channel communicatively coupling the backup power supply to the telecommunication switch; and
wherein the telecommunication switch comprises means for:
ascertaining the status of the backup power supply;
automatically terminating supply power to the telecommunication switch from the primary power supply; and
instructing, by the communication channel, the backup power supply to terminate power to the telecommunication switch.

28. The telecommunication system of claim 27 wherein the telecommunication switch further comprises means for automatically terminating supply of power to the telecommunication switch from the primary power supply in response to a determination that the backup power supply is available to provide power to the telecommunication switch.

29. The telecommunication system of claim 27 wherein the telecommunication switch further comprises means for automatically terminating supply of power to the telecommunication switch from the primary power supply in response to receiving an instruction to terminate the power supply from the primary power supply.

30. The telecommunication system of claim 27 wherein the telecommunication switch further comprises means for automatically terminating supply of power to the communication switch from the primary power supply by software command.

31. The telecommunication system of claim 27 wherein the telecommunication switch further comprises means for automatically terminating supply of power to the communication switch from the primary power supply by hardware command.

32. The telecommunication system of claim 27 wherein the telecommunication switch further comprises means for automatically terminating supply of power to the communication switch from the primary power supply by disabling a disable bit of the primary power supply.

33. The telecommunication system of claim 27 wherein the telecommunication switch further comprises means for automatically terminating supply of power to the communication switch from the primary power supply by terminating power output of the primary power supply.

34. The telecommunication system of claim 27 wherein the telecommunication switch further comprises means for automatically terminating supply of power to the communication switch from the primary power supply by terminating input of power from the primary power supply to the telecommunication switch.

35. An apparatus comprising:
a telecommunication switch operable to:
ascertain the status of a backup power supply;
automatically terminate power to the telecommunications switch from the primary power supply; and
instruct the backup power supply to terminate power to the telecommunication switch.

36. The apparatus of claim 35, wherein the telecommunication switch is further operable to automatically terminate supply of power to the telecommunication switch from the primary power supply in response to a determination that the backup power supply is available to provide power to the telecommunication switch.

37. The apparatus of claim 35, wherein the telecommunication switch is further operable to terminate supply of power to the telecommunication switch from the primary power supply in response to receiving an instruction to terminate the power supply from the primary power supply.

38. The apparatus of claim 35, wherein the telecommunication switch is further operable to automatically terminate supply of power to the communication switch from the primary power supply by software command.

39. The apparatus of claim 35, wherein the telecommunication switch is further operable to automatically terminate supply of power to the communication switch from the primary power supply by hardware command.

40. The apparatus of claim 35, wherein the telecommunication switch is further operable to automatically terminate supply of power to the communication switch from the primary power supply by disabling a disable bit of the primary power supply.

41. The apparatus of claim 35, wherein the telecommunication switch is further operable to automatically terminate supply of power to the communication switch from the primary power supply by terminating power output of the primary power supply.

42. The apparatus of claim 35, wherein the telecommunication switch is further operable to automatically terminate supply of power to the communication switch from the primary power supply by terminating input of power from the primary power supply to the telecommunication switch.
